(19) United States
(12) Patent Application Publication
(10) Pub. No.: US 2023/0237047 A1
(43) Pub. Date: Jul. 27, 2023

(54) FAST AND MEMORY-EFFICIENT DISTRIBUTED GRAPH MUTATIONS

(71) Applicant: Oracle International Corporation, Redwood Shores, CA (US)

(72) Inventors: Vasileios Trigonakis, Zurich (CH); Paul Renauld, Lausanne (CH); Jinsu Lee, Belmont, CA (US); Petr Koupy, Zurich (CH); Sungpack Hong, Palo Alto, CA (US); Hassan Chafi, San Mateo, CA (US)

(21) Appl. No.: 17/585,117

(22) Filed: Jan. 26, 2022

(51) Int. Cl. G06F 16/23; G06F 16/901

(52) U.S. Cl. CPC G06F 16/2379; G06F 16/9024

(57) ABSTRACT

Data structures and methods are described for applying mutations on a distributed graph in a fast and memory-efficient manner. Nodes in a distributed graph processing system may store graph information such as vertices, edges, properties, vertex keys, vertex degree counts, and other information in graph arrays, which are divided into shared arrays and delta logs. The shared arrays on a local node remain immutable and are the starting point of a graph, on top of which mutations build new snapshots. Mutations may be supported at both the entity and table levels. Periodic delta log consolidation may occur at multiple levels to prevent excessive delta log buildup. Consolidation at the table level may also trigger rebalancing of vertices across the nodes.

### RELATED CASES

This application is related to U.S. patent application Ser. No. 17/194,165 titled “Fast and memory efficient in-memory columnar graph updates preserving analytical performance” filed on Mar. 5, 2021 by Damien Hilloulin et al., and U.S. patent application Ser. No. 17/479,003 titled “Practical method for fast graph traversal iterators on delta-logged graphs” filed on Sep. 20, 2021 by Damien Hilloulin et al., which are incorporated herein by reference.

### FIELD OF THE INVENTION

The present disclosure relates to techniques for processing logical graphs. More specifically, the disclosure relates to supporting fast and memory-efficient graph mutations that are suitable for distributed graph computing environments.

### BACKGROUND

A graph is a mathematical structure used to model relationships between entities. A graph consists of a set of vertices (corresponding to entities) and a set of edges (corresponding to relationships). When data for a specific application has many relevant relationships, the data may be represented by a graph.

Graph processing systems can be split into two classes: graph analytics and graph querying. Graph analytics systems have a goal of extracting information hidden in the relationships between entities, by iteratively traversing relevant subgraphs or the entire graph. Graph querying systems have a different goal of extracting structural information from the data, by matching patterns on the graph topology.

Graph pattern matching refers to finding subgraphs, in a given directed graph, that are homomorphic to a target pattern. If the target pattern is (a)→(b)→(c)→(a), then corresponding graph walks or paths may include the following vertex sequences:
(1)→(2)→(3)→(1),
(2)→(3)→(1)→(2), and
(3)→(1)→(2)→(3)
   One hop corresponds to a graph walk consisting of a single edge. A walk with n edges is considered as a n-hop pattern.

There exist challenges to supporting a mutable graph stored in an in-memory graph database or graph processing engine while providing snapshot isolation guarantees and maintaining analytical performance on the graph. Particularly, when supporting a distributed graph, processing load and memory consumption should remain balanced across nodes for optimal analytical performance. This load balancing becomes increasingly difficult as the number of graph mutations increases.

### BRIEF DESCRIPTION OF THE DRAWINGS

The example embodiment(s) of the present invention are illustrated by way of example, and not in way by limitation, in the figures of the accompanying drawings and in which like reference numerals refer to similar elements and in which:

FIG. 1 is a block diagram that depicts an example distributed graph processing system in which fast and memory-efficient graph mutations may be supported.

FIG. 2A depicts an example vertex table with associated properties for a graph processing system.

FIG. 2B depicts an example vertex table for a distributed graph processing system.

FIG. 2C depicts an example shared map of a dictionary for a distributed graph processing system.

FIG. 3 is a block diagram that depicts an example vertex and edge table stored using a compressed sparse row (CSR) format.

FIG. 4 is a block diagram that depicts an example logical graph array with delta logs.

FIG. 5 is a block diagram that depicts example vertex and edge tables using a CSR format and with delta logs.

FIG. 6 is a block diagram that depicts a graph built using the tables from FIG. 5 with mutations from the delta logs.

FIG. 7 is a block diagram that depicts an example vertex table with delta logs and augmented with deleted bitset fields.

FIG. 8 is a block diagram that depicts example vertex and edge tables using a CSR format and with delta logs and deleted bitset fields.

FIG. 9 is a flow diagram that depicts an example process that a local node may perform to generate an in-memory representation of a distributed graph.

FIG. 10A is a flow diagram that depicts an example process that a local node may perform to apply entity-level mutations for vertices on a distributed graph to generate a new graph.

FIG. 10B is a flow diagram that depicts an example process that a local node may perform to apply entity-level mutations for edges on a distributed graph to generate a new graph.

FIG. 11 illustrates a block diagram of a computing device in which the example embodiment(s) of the present invention may be embodiment.

FIG. 12 illustrates a block diagram of a basic software system for controlling the operation of a computing device.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

Data structures and methods are described for supporting mutations on a distributed graph in a fast and memory-efficient manner. Nodes in a distributed graph processing system may store graph information such as vertices, edges, properties, vertex keys, vertex degree counts, and other information in graph arrays, which are divided into shared arrays and delta logs. In some implementations, graph arrays can be divided into fixed sized segments to enable localized consolidation. In some implementations, edges may be tracked in both forward and reverse directions to accelerate analytic performance at the cost of memory.

Shared arrays represent original graph information that is shared with all nodes, whereas delta logs represent local mutations, e.g. updates, additions, or deletions to the shared arrays by a local node. Iterators may be provided to logically access the graph arrays as unified single arrays that represent the reconstructed mutated graph, or the shared arrays with the delta logs applied on the fly.

Nodes may be responsible for mutually exclusive sets of vertices, except for high degree “ghost” vertices that are replicated on every node. The assigning of vertices to nodes may distribute vertices of the same degree approximately uniformly, thereby providing an approximately even distribution of work and memory consumption to the nodes. The distribution may utilize a hash function as randomness to approximate a uniform balancing.

To identify and reference the vertices, a dictionary may be provided at each node to map vertex keys to nodes and internal table/index identifier tuples. The dictionary may include a shared map that is duplicated among nodes and a local map for local node mapping updates like the delta logs for the graph information as described above.

The shared arrays on a local node are accessible directly from remote nodes without requiring a copy or replication operation. For example, the shared arrays may be accessed using remote direct memory access (RDMA), shared references, message passing, or similar techniques. Since the shared arrays may be proportionally large compared to the delta logs and may remain at each node without replication, memory footprint and replication overhead may be minimized at each node.

Local delta logs may be replicated or copied between nodes when reconstructing the mutated distributed graph, e.g. prior to executing analytic tasks. Mutations may be supported at both the entity and table levels. To minimize reconstruction overhead, periodic delta log consolidation may occur at multiple levels to limit the size of the delta logs, thereby preserving analytic performance. Consolidation at the table level may also trigger rebalancing of vertices across the nodes to preserve an even distribution of work and memory consumption.

### Example Distributed Graph Processing System

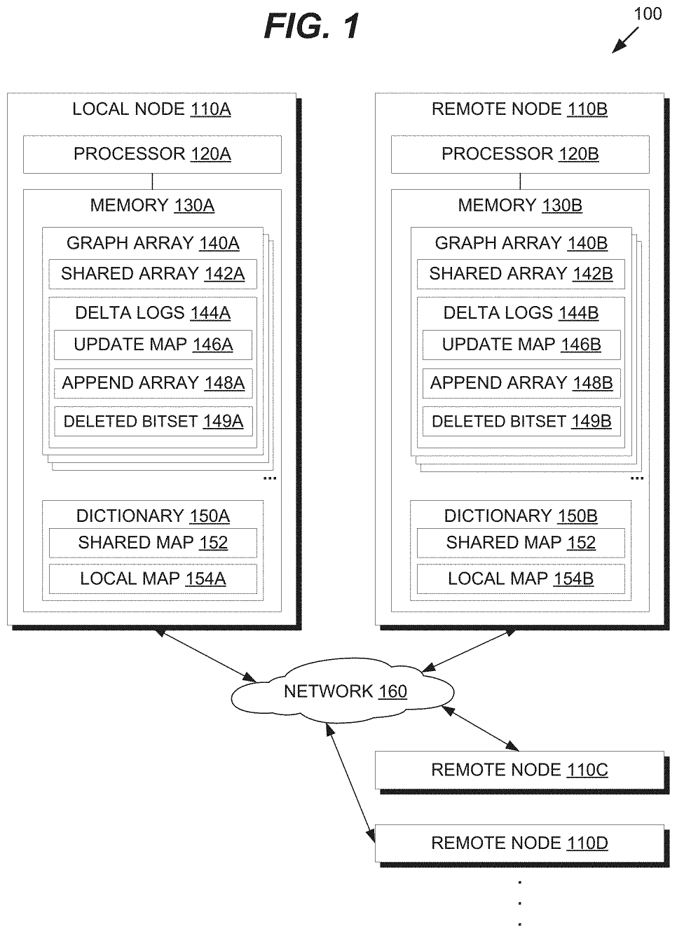

FIG. 1 is a block diagram that depicts a distributed graph processing system 100 in which fast and memory-efficient graph mutations may be supported. System 100 includes local node 110A, remote nodes 110B, 110C, and 110D, and network 160. Local node 110A includes processor 120A and memory 130A. Memory 130A includes one or more graph array 140A and dictionary 150A. Graph array 140A includes shared array 142A and delta logs 144A. Delta logs 144A includes update map 146A, append array 148A, and deleted bitset 149A. Dictionary 150A includes shared map 152 and local map 154A. Remote node 110B includes processor 120B and memory 130B. Memory 130B includes one or more graph array 140B and dictionary 150B. Graph array 140B includes shared array 142B and delta logs 144B. Delta logs 144B includes update map 146B, append array 148B, and deleted bitset 149B. Dictionary 150B includes shared map 152 and local map 154B.

As shown in FIG. 1, graph processing may be distributed across multiple processing nodes, or nodes 110A-110D. Each of nodes 110A-110D may be one or more of a rack server such as a blade, a personal computer, a mainframe, a virtual computer, or other computing device. For illustrative purposes, node 110A is specifically illustrated as a local node, which in turn renders the remaining nodes 110B-110D as remote nodes. Additional remote nodes may also be present that are not specifically shown. Further, remote nodes 110C and 110D may contain similar elements as remote node 110B, but the elements are omitted for illustrative purposes.

To divide the graph processing workload and memory footprint evenly across the nodes, a hash function may be utilized as randomness to approximate a uniform balancing of the vertices of a graph to a responsible node or data owner. For example, using the hash function may provide an approximately uniform distribution for vertices of each degree, resulting in vertices with 1 edge approximately uniformly distributed across nodes, vertices with 2 edges approximately uniformly distributed across nodes, vertices with 3 edges approximately uniformly distributed across nodes, and so on. Each node is then responsible for tracking mutations applied to their respective vertices assigned by the hash function. Thus, each vertex may be assigned to a single node or data owner, except for ghost vertices, or vertices exceeding a threshold degree that are tracked at each node independently to reduce communication overhead.

The assignments of vertices to nodes may be stored in dictionary 150A for local node 110A. Each entry in shared map 152 may map an externally referenceable, user specified vertex key to an internally identifying vertex tuple. For example, the tuple may include a machine or node identifier, a vertex table identifier, and a vertex table index. In an example tuple, the node identifier may select from nodes 110A-110D, e.g. remote node 110B, the vertex table identifier may select from a specific graph array 140B, and the vertex table index may select an index within shared array 142B of the selected specific graph array 140B.

The assignments of vertices to nodes may be stored in dictionary 150B for remote node 110B. As shown in FIG. 1, the same shared map 152 may be duplicated across nodes, whereas the local maps 154A and 154B contain local mapping updates for each respective node 110A and 110B.

The index associated with a vertex is a numerical identifier unique for each node, which is referred to as a physical vertex index. Initially, when a table is created, the index is in the range [0,V-1] where V is the number of vertices during table loading. In an implementation, the physical vertex index of valid vertices remains persistent across different snapshots of the graph as long as the vertices are not deleted and can therefore be used as index into properties. Whenever new vertices are added, they may take the place of previously deleted vertex, which is referred to herein as a vertex compensation.

A deleted bitset array indicates, for each physical vertex index, if the corresponding vertex is deleted in the current snapshot or not. In an implementation, one such deleted bitset array is created per snapshot. Having such physical vertex indices stable across snapshots makes it possible to minimize disruptive changes for the edges. Deleted bitset arrays may also be provided for edge tables as well. To reduce the memory footprint of deleted bitset arrays, the deleted bitset array may remain unallocated at each node until a deletion is introduced, and/or compressed representations such as run length encoded (RLE) arrays may be used as the deleted bitset array may be sparse with a relatively small number of deletions.

When local node 110A needs to perform updates to shared map 152, the updates are stored separately in local map 154A. For example, if a new vertex is created or an existing vertex is modified or deleted, e.g. by mapping to null or another reserved identifier, the mapping update for the affected vertex is stored in local map 154A. In this manner, shared map 152 can be preserved to reference the original distributed graph without mutations. When local node 110A needs to perform a vertex lookup for the distributed graph with mutations applied, the vertex key is first queried in local map 154A. This query may be omitted if local map 154A is empty. If the vertex key is not found in local map 154A, the vertex key is queried in shared map 152.

Graph array 140A and 140B may correspond to any type of graph array, such as a vertex array, an edge array, a property array, a degree array, or any other type of information pertaining to the distributed graph. Each node may include multiple graph arrays needed to store the vertices, edges, properties, and other related graph data assigned to each respective node. Referring to graph array 140A, each graph array may include two portions: shared array 142A and delta logs 144A.

Shared array 142A corresponds to data for the original distributed graph without any mutations applied. Since the content of the shared array depends on the vertices tracked by each node, each node contains its own independent shared array. The shared arrays are shared in the sense that the shared arrays form a baseline graph that is shared across snapshots of mutated graphs. The shared arrays are also shared in the sense that other nodes can access the shared arrays directly without performing a replication or copy operation. Thus, remote node 110B can access shared array 142A without performing a copy, and local node 110A can access shared array 142B without performing a copy. For example, the shared arrays may be exposed to remote nodes via RDMA or other techniques. In this manner, memory footprint can be distributed evenly among the nodes while reducing duplication overhead.

To provide snapshot isolation guarantees, both the original distributed graph and the mutated distributed graph should be accessible at any given time. Accordingly, mutations to the distributed graph are stored separately as delta logs, which reflect the mutations to the original distributed graph. When local node 110A needs to access the original distributed graph, it can be accessed directly from the shared array 142A. When local node 110A needs to access the mutated distributed graph, it can be reconstructed by applying delta logs 144A on the fly to shared array 142A without directly modifying shared array 142A. Delta logs 144A may include update map 146A, which includes updates or deletions for shared array 142A, append array 148A, which includes new entries for shared array 142A, and deleted bitset 149A, which may include deletions for existing entries in shared array 142A or append array 148A. When there are no modifications, then update map 146A may be empty. Similarly, when there are no new additions, then append array 148A may be empty.

Since the graph is distributed, local node 110A may refer to dictionary 150A and determine that a vertex to be looked up is maintained on a remote node, for example remote node 110B. In this example, for each graph array 140B, the shared array 142B can be accessed directly, whereas the delta logs 144B may be replicated or copied over network 160 and applied on the fly to shared array 142B to reconstruct the mutated graph at local node 110A. Since only the delta logs 144B are copied while the shared array 142B remains in place, replication overhead over network 160 can be thereby reduced, especially when the delta logs are relatively small compared to the shared array. To maintain this performance benefit, delta logs may be constrained by a size threshold. When the size threshold is exceeded, a consolidation operation may be carried out to create a new snapshot while applying and emptying the delta logs, as described in further detail below.

### Example Vertex To Node Distribution

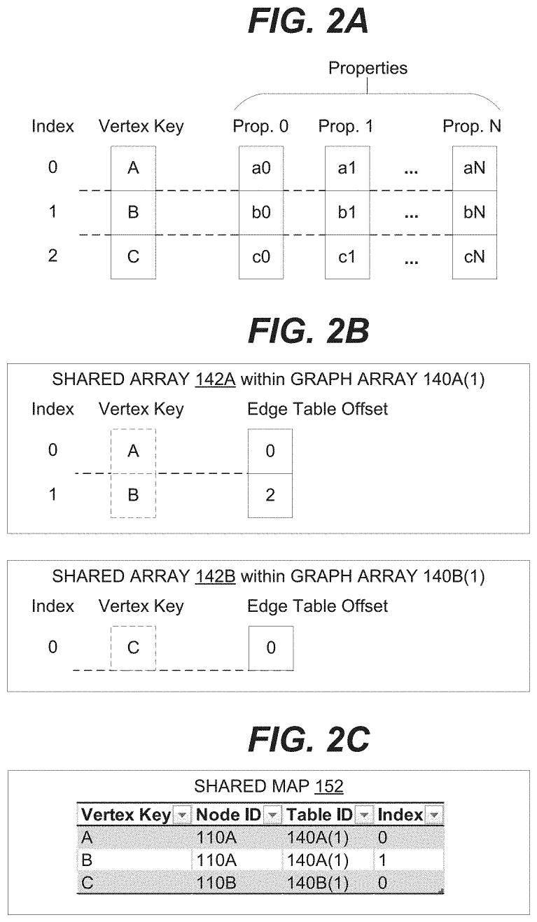

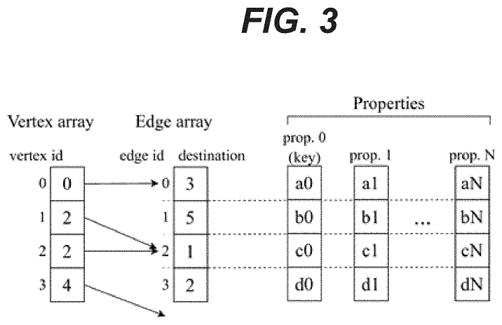

FIG. 2A depicts an example vertex table with associated properties for a graph processing system. As shown in FIG. 2A, three vertices are listed, which are referenced by vertex keys “A”, “B”, and “C”. Each vertex is associated with N properties. As shown in FIG. 3, the vertex key may also be considered as a first property of the N properties. As discussed above, each vertex is assigned to a responsible node in the distributed system 100 shown in FIG. 1, for example by using a hash function.

FIG. 2B depicts example vertex tables for a distributed graph processing system. For example, assume that vertex “A” and vertex “C” have the same degree of 2 edges. In this case, system 100 should distribute vertex “A” and “C” evenly amongst the available nodes. In some implementations, system 100 may utilize a hash function applied to the vertex key as randomness to provide an approximation of an even distribution. For simplicity, assume that only nodes 110A and 110B are available for graph processing. In this case, system 100 may provide an even distribution by assigning vertex “A” to node 110A and vertex “C” to node 110B. For the remaining vertex “B”, which may have a degree of 1 edge, system 100 may assign to node 110A. Thus, node 110A is assigned to vertex “A” and vertex “B”, whereas node 110B is assigned to vertex “C”. Thus, shared array 142A contains entries for vertex keys “A” and “B”, whereas shared array 142B has an entry for vertex key “C”. The indicator (1) for graph array 140A and 140B is included to identify a first vertex table, as each node may potentially include multiple vertex tables.

Note that the vertex keys in shared array 142A and 142B are only shown for illustrative purposes, as the actual arrays may be single dimensional (1-D) arrays that include edge table offsets, which point to indexes in separate edge tables using a compressed sparse row (CSR) format, as described below in FIG. 3. While CSR is used as an example format, any graph format including adjacency lists may also be utilized.

Besides vertex tables, each node may also store graph arrays for edge tables, for each property N, for vertex degrees, and for other graph data. For example, node 110A may also store an edge table with two indexes to track forwards edges for vertices “A” and “B”, and N property tables each having two indexes to store the N properties for vertices “A” and “B”. As discussed above, in some implementations, reverse edges may also be tracked as well.

FIG. 2C depicts an example shared map 152 of a dictionary for a distributed graph processing system. As shown in FIG. 2C, each externally referenceable vertex key is mapped to an internally identifiable tuple, or a node ID, table ID, and index. Once the tuple is known, then associated data stored in other graph arrays can also be accessed using the same index, for example to retrieve properties, degree, and other graph data. Edges may be retrieved from an edge table by using the edge table offsets retrieved from the vertex table. As discussed above, if the vertex key points to an external or remote node, then the vertex, edges, and other graph arrays can be accessed directly from the shared arrays on the remote node and the remote delta logs can be replicated and used to reconstruct the mutated graph.

### Compressed In-Memory Graph Format

FIG. 3 is a block diagram that depicts an example vertex and edge table stored using a compressed sparse row (CSR) format. Since the distributed graph is stored in-memory, it is advantageous to store the graph data in a compressed format to minimize memory footprint. One format particularly suitable for graph analysis is the CSR format. In this format, the vertex table does not directly store edges, but points to offsets in a separate edge table. Based on the offsets of two adjacent indexes, the number and identity of edges belonging to a vertex can be determined.

For example, referring to the example shown in FIG. 3, vertex ID 0 points to offset 0 in the edge table, and vertex ID 1 points to offset 2 in the edge table. Based on this, it is known that the edges associated with vertex ID 0 begin at offset 0 or index 0 in the edge table, and there are (2−0) or 2 edges, or edge ID 0 and edge ID 1. Thus, vertex ID 0 has two forward edges with destination vertices 3 and 5. Similarly, vertex ID 1 has no edges, vertex ID 2 has 2 edges with destination vertices 1 and 2, and vertex ID 3 has no edges since the offset is past the end of the edge table. An additional edge table can also be used to track reverse edges as well.

### Logical Graph Array with Delta Logs

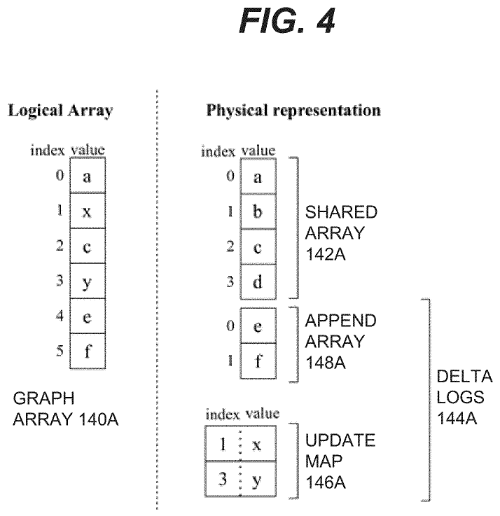

FIG. 4 is a block diagram that depicts an example logical graph array with delta logs. As shown in FIG. 4, graph array 140A logically represents a single dimensional (1-D) array but is physically represented by the combination of shared array 142A and delta logs 144A, wherein the delta logs 144A may include update map 146A and/or append array 148A. To simplify access to the logical array, an iterator may be provided to access logical arrays based on the physical representation, thereby abstracting the delta log format. Further, while not specifically shown in FIG. 4, the delta logs 144A may also include updates for deleted bitsets, thereby deleting an existing entry. Note that the physical representation does not directly apply the delta logs 144A to the existing shared array 142A, thereby preserving the original snapshot state of the graph.

### Multiple Edge Neighborhoods for CSR Format

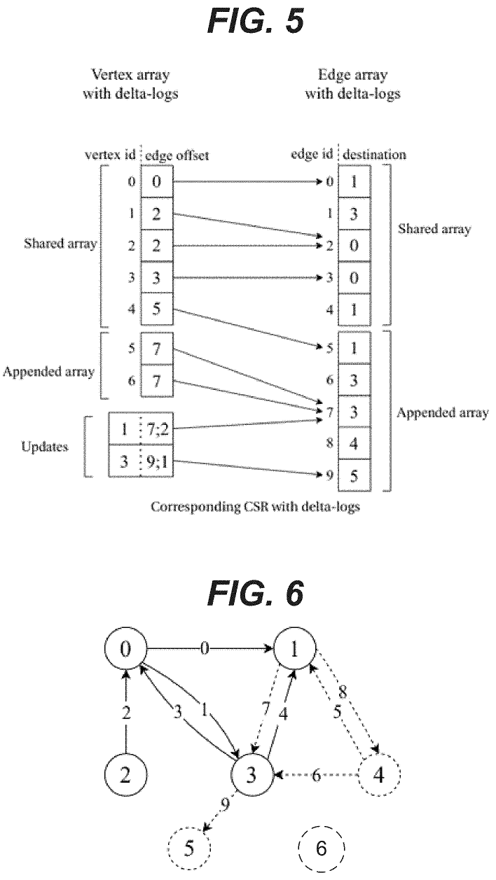

FIG. 5 is a block diagram that depicts example vertex and edge tables using a CSR format and with delta logs. To support the addition of edges to existing vertices in a graph using a CSR format, a naive approach may require the edge table to be rewritten every time a new edge is inserted, and the modified edge offsets would also need to be updated in the vertex table. Since this approach is computationally costly, an alternative approach is described wherein a vertex may be associated with multiple edge neighborhoods in an edge table that collectively describe the edges associated with the vertex. While this increases fragmentation in the edge table, the fragmentation may be offset by the overall reduction in computational overhead and memory consumption.

For example, as shown in FIG. 5, entries in an update map for the vertex table may include the vertex ID and a tuple that identifies an edge table offset and a quantity of edges. Thus, an edge table offset for an existing vertex may be positioned in a neighborhood within the append array that is separate from any existing neighborhood within the shared array. The append array is provided to allow new edges to be inserted in the edge table. Since vertex ID 4 is the last entry in the shared array, adding new edges to existing vertex ID 4 does not require a separate neighborhood and the next entry, or vertex ID 5 in the append array, can be used as usual to define the number of edges for vertex ID 4, or (7−5)=2. However, for updates to existing vertex IDs that are not the last vertex ID, entries in the update map may instead reference separate neighborhoods in the append array within the edge table.

For example, referring to the update map, edge ID 7 and edge ID 8 are added to vertex ID 1, whereas edge ID 9 is added to vertex ID 3. Thus, vertex ID 1 now has edges with destination IDs 7 and 8, whereas vertex ID 3 now has edges with destination IDs 0, 1, and 5. This can be visualized by referring to FIG. 6, a block diagram that depicts a graph built using the tables from FIG. 5 with mutations from the delta logs illustrated using dashed lines. As shown in FIG. 6, vertex 1 has an edge 7 directed at vertex 3 and an edge 8 directed at vertex 4, whereas vertex 3 has an edge 3 directed at vertex 0, an edge 4 directed at vertex 1, and an edge 9 directed at vertex 5. Thus, each vertex may now reference multiple edge neighborhoods in the edge table: one in the shared array which is referenced using the usual CSR format, and one or more in the append array that are referenced using offsets and explicit lengths in the update map. Since entity level mutations may be received one at a time and future entries for the update map may be unknown, explicit lengths may be provided in the update map.

### Deleted Bitset

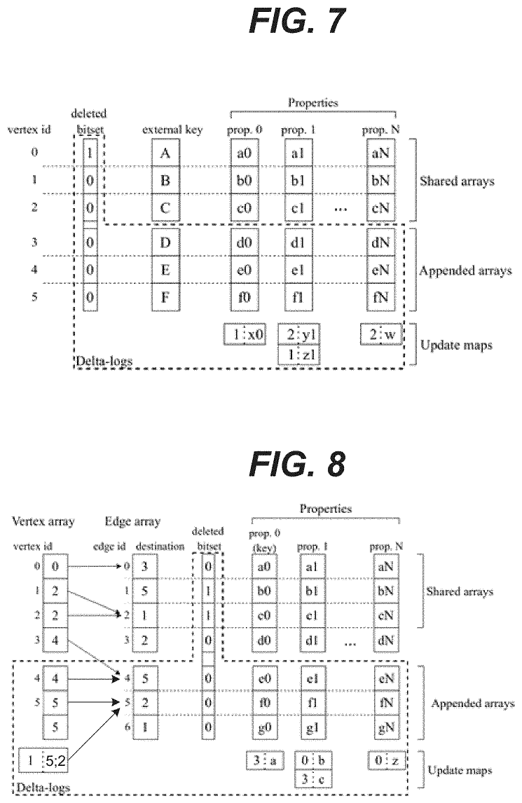

FIG. 7 is a block diagram that depicts an example vertex table with delta logs and augmented with deleted bitset fields. To support mutations that delete elements such as vertices and edges, a naive approach may again incur a significant overhead penalty due to the reconstruction of the data structures after deleting an element. To avoid this overhead, graph arrays may be augmented with a deleted bitset field, which describes whether an associated index should be treated as deleted in the mutated graph. The deleted bitset field may be physically stored as a separate property array. Updates that delete an entry may set the deleted bitset field while leaving the existing data structures intact.

Using the example shown in FIG. 7, the original graph without mutations can be referenced from the shared array, or vertex ID 0 through 2, while ignoring the deleted bitset field. To instead access the mutated graph, each vertex with a deleted bitset set to 1 can be considered as deleted. Thus, vertex ID 0 can be considered deleted from the mutated graph. When a vertex deletion mutation is received in the future, the deleted bitset for the corresponding vertex can be set to 1, rather than adding an entry into the update maps.

Besides the deletion of vertex ID 0, the delta logs in FIG. 7 also include an append array of three new vertices, or vertex ID 3 through 5, and modifications to existing vertex properties via update maps. The updates include updating index 1 of the property 0 array with the value “x0”, updating index 2 of the property 1 array with the value “y1”, updating index 1 of the property 1 array with the value “z1”, and updating index 2 of the property N array with the value “w”.

FIG. 8 is a block diagram that depicts example vertex and edge tables using a CSR format and with delta logs and deleted bitset fields. Edges may also be augmented with deleted bitset fields. In the example shown in FIG. 8, edge ID 1 and 2 are deleted in the mutated graph, as indicated by the deleted bitset field.

Further, in the delta logs, new edge IDs 4 through 6 are added by an append array, wherein the CSR format indicates that vertex ID 4 has one forward edge, or edge ID 4, and vertex ID 5 has no edges. The vertex table in FIG. 8 may correspond to the vertex table in FIG. 7, and thus six vertices may be present. While the vertex array in FIG. 8 includes an index 6, this is not associated with a vertex but is included so that the number of edges associated with vertex ID 5 can be determined in the CSR format. This is also why the vertex array portion of the delta logs start at index 4 in FIG. 8 rather than at index 3 as in FIG. 7. Further, an update map is provided to add two new edges to vertex ID 1, or edge ID 5 and 6, as indicated by the 1:5; 2 delta log, using the offset and explicit length format as described above for the multiple edge neighborhoods.

The delta logs in FIG. 8 also include an append array of three new edges, or edge ID 4 through 6, and modifications to existing edge properties via update maps. The updates include updating index 3 of the property 0 array with the value “a”, updating index 0 of the property 1 array with the value “b”, updating index 3 of the property 1 array with the value “c”, and updating index 0 of the property N array with the value “z”

### Example Distributed Graph Generation Process

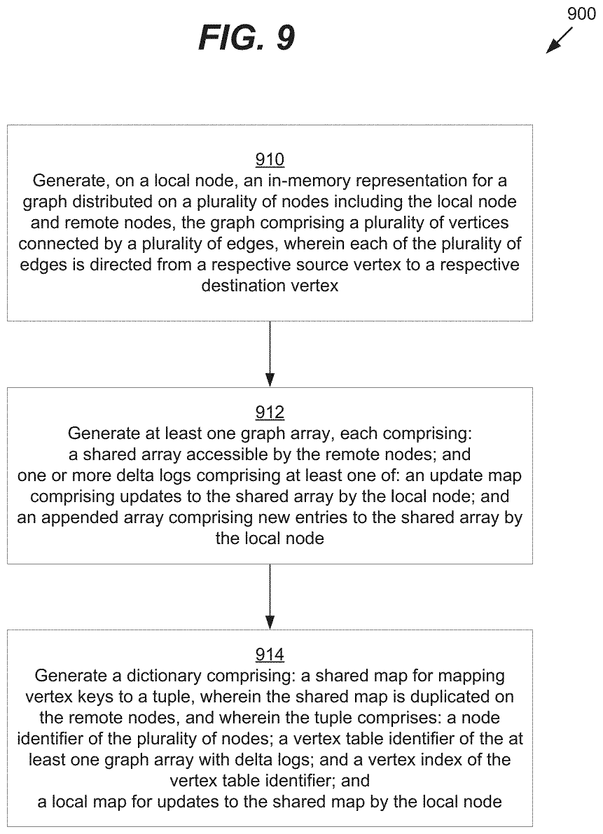

FIG. 9 is a flow diagram that depicts an example process 900 that local node 110A may perform to generate an in-memory representation of a distributed graph.

Block 910 generates, on local node 110A, a representation in memory 130A for a graph distributed on a plurality of nodes including local node 110A and remote nodes 110B-110D, the graph comprising a plurality of vertices connected by a plurality of edges, wherein each of the plurality of edges is directed from a respective source vertex to a respective destination vertex. As discussed above, a distribution using a hash function may be used to assign each node to a set of mutually exclusive vertices and associated edges, except for ghost vertices that are duplicated at each node.

Block 912 generates at least one graph array 140A, each comprising: shared array 142A accessible by the remote nodes 110B-110D, and one or more delta logs 144A comprising at least one of: update map 146A comprising updates to shared array 142A by local node 110A, and append array 148A comprising new entries to shared array 142A by local node 110A. As discussed above, the graph arrays with delta logs are general data structures that can represent various types of data such as vertex tables in CSR format, edge tables in CSR format, vertex keys, property tables for vertices, property tables for edges, vertex degree counts, and other data.

Block 914 generates dictionary 150A comprising shared map 152 for mapping vertex keys to a tuple, wherein shared map 152 is duplicated on remote nodes 110B-110D, and wherein the tuple comprises: a node identifier of nodes 110A-110D, a vertex table identifier of one of the graph array 140A, and a vertex index of the vertex table identifier. Using the shared map 152, nodes 110A-110D can reference the node and table locations for vertices referenced by a vertex key. Further, the dictionary 150A includes local map 154A for updates to shared map 152 by local node 110A. The updates may include, for example, mappings of new vertices assigned to local node 110A.

### Example Process for Applying Mutations to Vertices

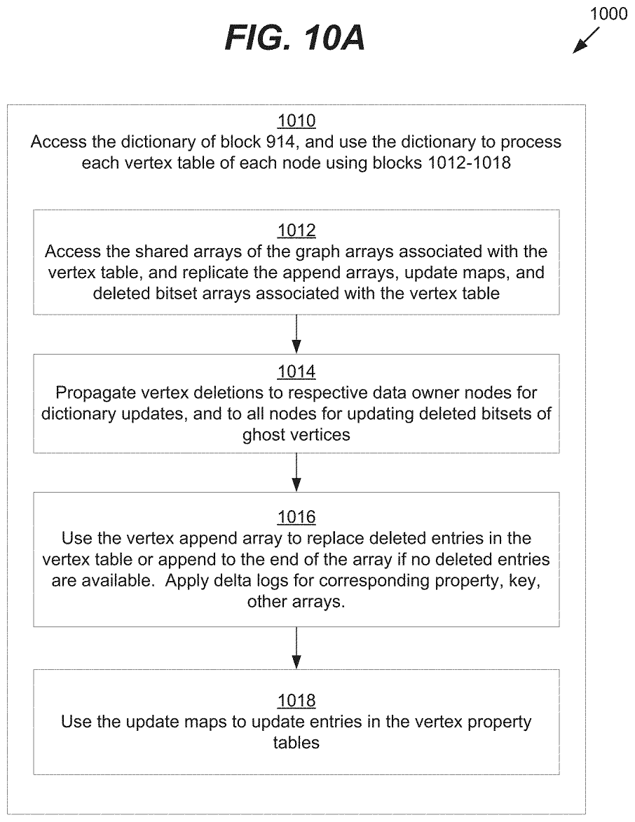

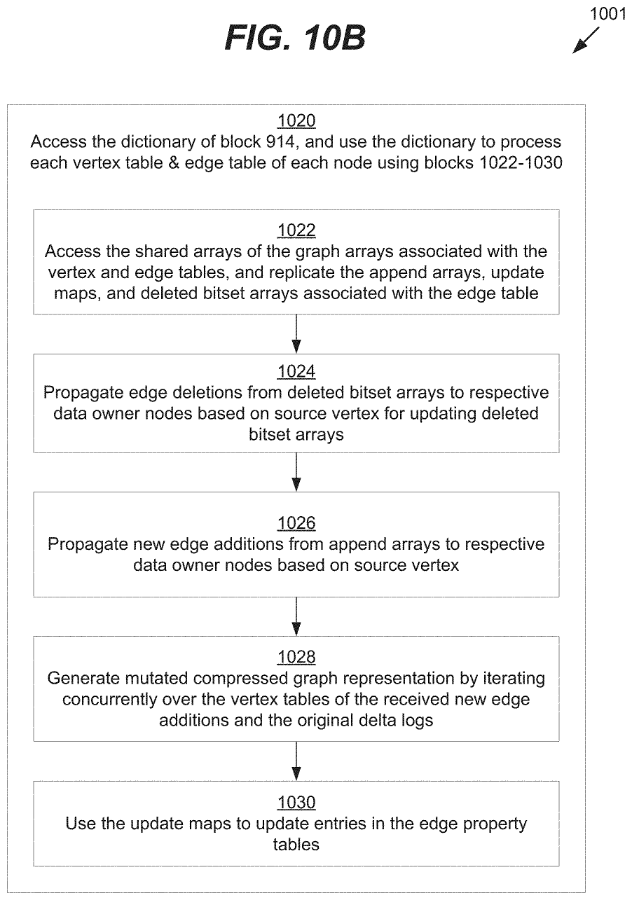

FIG. 10A is a flow diagram that depicts an example process 1000 that local node 110A may perform to apply entity-level mutations for vertices on a distributed graph to generate a new graph.

Referring to FIG. 1, block 1010 accesses dictionary 150A and uses dictionary 150A to process each vertex table of each node 110A-110D using blocks 1012-1018. As discussed above, the shared map 152 that is duplicated on each node, including local node 110A, can be used to reference, by vertex key, the vertices in the shared arrays associated with nodes 110A-110D. Further, the delta logs that are associated with each remote node 110B-110D can be replicated for local processing at local node 110A.

For each vertex table across the nodes, block 1012 accesses the shared arrays of the graph arrays associated with the vertex table, and replicates the append arrays, update maps, and deleted bitsets associated with the vertex table. The graph arrays may include, for example, a vertex table, vertex property arrays, a vertex key array, and a degree array. For example, in the case of graph array 140B corresponding to a vertex table, the shared array 142B is accessed by reference, whereas the delta logs 144B are replicated, including update map 146B, append array 148B, and deleted bitset 149A.

For each vertex table from the data of block 1012, block 1014 propagates vertex deletions to respective data owner nodes for dictionary updates, and to all nodes for updating deleted bitsets of ghost vertices. For example, vertices indicated as deleted in the deleted bitsets replicated from block 1012 are propagated to their respective data owner for updating local node metadata. For example, dictionary entries at each node may be set to a null or another reserved value to indicate vertex keys that have been deleted. In the case of ghost vertices, the ghost vertices may occupy a reserved area at the top or head of the vertex tables, and these entries may be marked as deleted for each node, e.g. by setting the corresponding deleted bitset value.

For each vertex table from the data of block 1012, block 1016 uses the vertex append array to replace deleted entries in the vertex table or append to the end of the array if no deleted entries are available. For example, in the case of graph array 140B corresponding to a vertex table, the append array 148B is processed to replace vertex entries in shared array 142A that are marked as deleted in deleted bitset 149A, and the corresponding bits are unset to indicate the entries are not deleted. Once shared array 142A runs out of deleted entries to replace, then the new entries from append array 148B are added to append array 148A. Further, shared arrays from other associated tables such as the vertex property arrays and vertex key array are applied to update their respective arrays in an associated graph array 140A.

For each vertex table from the data of block 1012, block 1018 uses the update maps to update entries in the vertex property tables. For example, in the case of graph array 140B corresponding to a vertex property array, the updates are applied locally to shared array 142A of graph array 140A corresponding to the same vertex property array. This is repeated for all vertex properties. After block 1010 is completed, vertex additions, deletions, and modifications are implemented in a new graph defined by the updated data structures in local node 110A.

### Example Process for Applying Mutations to Edges

FIG. 10B is a flow diagram that depicts an example process 1001 that local node 110A may perform to apply entity-level mutations for edges on a distributed graph to generate a new graph. The process 1001 may be repeated twice when supporting both forward and reverse edges. In the case of reverse edges, modified and deleted edges are first sent to the data owner of the indicated vertex destination since the reverse edges start at the destination and end at the source.

Referring to FIG. 1, block 1020 accesses dictionary 150A and uses dictionary 150A to process each vertex and edge table of each node 110A-110D using blocks 1022-1030. As discussed above, the shared map 152 that is duplicated on each node, including local node 110A, can be used to reference, by vertex key, the vertices in the shared arrays associated with nodes 110A-110D. Further, the delta logs that are associated with each remote node 110B-110D can be replicated for local processing at local node 110A.

For each vertex and edge table across the nodes, block 1022 accesses the shared arrays of the graph arrays associated with the vertex and edge tables, and replicates the append arrays, update maps, and deleted bitsets associated with the edge table. Process 1000 may have already been applied previously, in which case the vertex tables and associated data are already replicated at local node 110A. In this case, the graph arrays may include, for example, an edge table and edge property arrays. For example, in the case of graph array 140B corresponding to an edge table, the shared array 142B is accessed by reference, whereas the delta logs 144B are replicated, including update map 146B, append array 148B, and deleted bitset 149A.

For each vertex and edge table from the data of block 1022, block 1024 propagates edge deletions from the replicated data of block 1022 to respective data owner nodes based on source vertex for updating deleted bitset arrays. The source vertex defined in the edge defines the data owner for forward edges. For example, edges indicated as deleted in the deleted bitsets replicated from block 1022 are propagated to their respective data owner for updating local node metadata. For example, deleted bitset array indexes for edge tables at each node may be set to indicate edges that have been deleted.

For each vertex and edge table from the data of block 1022, block 1026 propagates new edge additions from edge append array to respective data owner nodes based on source vertex. For example, in the case of graph array 140B corresponding to an edge table, the append array 148B is processed to send new edges to the respective data owner, which can be determined based on the source vertex indicated in the vertex table.

For each vertex table and edge table from the data of block 1022, block 1028 generates a mutated compressed graph representation by iterating concurrently over the vertex tables of the received new edge additions from block 1026 and the original delta logs previously duplicated from block 1022. For example, both the original delta logs and the new edge additions may be formatted into CSR format. By iteratively merging both CSRs concurrently, all edges for a given vertex may be grouped together in the merged CSR. In this manner, the vertex and edge tables can be reconstructed correctly in the mutated compressed graph representation.

For each vertex table and edge table from the data of block 1022, block 1030 uses the update maps to update entries in the edge property tables. For example, in the case of graph array 140B corresponding to an edge property array, the updates are applied locally to shared array 142A of graph array 140A corresponding to the same edge property array. This is repeated for all edge properties. After block 1020 is completed, the forward CSR of the edge table is rebuilt. As discussed above, process 1001 may be repeated to handle the reverse CSR as well. After both process 1000 and 1001 are completed, the new graph is reconstructed at local node 110A with all mutations implemented, which may correspond to a new snapshot.

### Table Level Mutations

The above examples have described element-level mutations, or mutations that affect one element at a time. Table-level mutations can also be supported, such as when loading from a file or another data source to add new tables or delete existing tables. In this case, existing entity tables that are not deleted by the table-level mutation can be retained in the new graph, remaining at the same index in a table array and using the same table ID. The shared arrays are accessed by reference, and the delta logs are replicated without modification.

When the mutations delete a table, the table is not actually deleted, but is set as a tombstone table, or a special indicator that the table is empty and should not be accessed. This is to preserve the ordering of table IDs in the table array.

When the mutations add a new table, a loading pipeline is utilized to read the graph from a file or another data source, first by reading the vertex and edge tables, and second by storing the tables in intermediate data structures that are usable to reconstruct the graph. The pipeline is modified to prevent any existing tables to be added to the intermediate data structures. This generalization allows the edge tables to be reconstructed by reading vertex information from the intermediate structures for new vertex tables, or from the original graph for existing vertex tables. Vertex tables can be reconstructed normally without modifications to the pipeline. The new tables replace any tombstone tables, if available, or are otherwise appended to the end of the table array.

### Consolidation

As discussed above, when the delta logs exceed a size threshold, a consolidation action may be triggered to apply and clear the delta logs. The size threshold may, for example, be set as a ratio of the shared arrays, or by other criteria. By keeping the delta logs below the size threshold, reconstruction overhead can be kept to a minimum to preserve high analytical performance. Since consolidation is an expensive operation, consolidation may be triggered at various levels to delay large scale consolidation operations.

Consolidation may occur at the array level. In this case, each node can consolidate its own graph arrays, regardless of the data type (vertex, edge, property, etc.) and without coordination with other nodes. However, consolidation of CSR or other compressed formats may be avoided due to the reconstruction overhead. For example, referring to graph array 140A, the delta logs 144A may be applied to shared array 142A by adding the new entries from append array 148A and applying the changes from update map 146A and deleted bitset 149A. Once the new graph array 140A is thereby consolidated, the delta logs 144A may be emptied.

Consolidation may occur at the CSR level. In this case, the vertex and edge tables and edge property arrays are reconstructed, and any multiple edge neighborhoods are consolidated into a single edge neighborhood. The deleted bitsets for the vertices and edges may also be emptied. This operation does not require coordination with other nodes and can be performed independently for both forward and reverse edges. This consolidation may be especially useful when many edges are added or modified on a specific node.

Consolidation may occur at the table level. This is equivalent to applying table level mutations, as described above. Thus, this operation cannot be done independently on a single node and coordination with other nodes is required. All delta logs on all nodes are empty after this operation. Since this operation may result in numerous modifications to the graph, it may be efficient to perform rebalancing at the same time of table level consolidation, as discussed below.

Consolidation may also occur at a segment level. A graph may be divided into segments or chunks of a fixed size, which are identified using a segment array. Segments may therefore function as a fixed size portion of a graph array. Consolidation may then be triggered on a per-segment basis proceeding similarly to the array level consolidation described above, thereby allowing for finer consolidation granularity for more localized consolidation compared to the table level.

### Rebalancing

When significant mutations are applied to a graph, the graph may become unbalanced, thereby skewing the original load balanced distribution across the nodes. In this case, a rebalancing operation may be carried out to provide a new load balanced distribution across the nodes. Since this operation is expensive, it may be carried out at the same time as table level consolidation when a threshold number of mutations (e.g. edge additions) are applied to existing vertices, as discussed above. The rebalancing may be carried out by repeating the distribution of vertices using the hash function as described above.

When the mutations are primarily for newly added vertices, then a separate rebalancing may be triggered for the new vertices only. In this case, before the new vertices are applied to a local node, the nodes can exchange the new vertices among themselves so that the additions are balanced. For example, by using vertex degree arrays, the degree of existing vertices and new vertices can be compared, and the new vertices can be assigned in a balanced manner across the nodes. When vertex degree arrays are not available, the degrees may be calculated on demand. The nodes can then exchange dictionary mapping information to reference and locate the new vertices on each node.

### Ghost Vertices

When vertices have a degree that exceeds a threshold, then the vertices may be treated as ghost vertices, or vertices that are duplicated at each node. This helps to avoid excessive communications overhead between nodes. For example, a reserved portion at the top or head of the vertex and edge arrays may be used to store the ghost vertices at each node. The degree threshold may be set lower for initial table loading and higher for mutations, since a later conversion of a normal vertex into a ghost vertex or a ghost promotion may be an expensive process.

To perform ghost promotion, table level consolidation of vertex tables may be carried out as described above. However, since this operation incurs significant overhead, the reserved portion in the arrays may instead be used to add new ghost vertices. If empty or previously deleted ghost vertex entries are available, the new ghosts can replace these entries. Otherwise, if the reserved portion becomes full, then entries for normal vertices in the array may be relocated to expand the reserved portion.

Since each node replicates the ghost vertices, the ghost promotion also needs to be broadcast to the other nodes. For example, the data owner or local node of a vertex V that is promoted to a ghost vertex G may send a promotion message to remote nodes, which includes the vertex ID V, the ghost vertex ID G, associated properties of V, and edges from V to vertices owned by the remote nodes. The remote nodes create a ghost replica G with the origin vertex V and add the properties. The remote nodes add to G any edges from V to local vertices. The remote nodes updates reverse edges from a local vertex to V by changing the destination vertex to G, which may be represented in update maps for the edge arrays. The local node then deletes the edges of V, since the edges are now associated with G. At this point, the ghost promotion is propagated to all the nodes. This promotion may be especially useful for table level mutations, as the ghost promotion can occur prior to adding numerous edges to a vertex.

### Database Overview

Embodiments of the present invention are used in the context of database management systems (DBMSs). Therefore, a description of an example DBMS is provided.

Generally, a server, such as a database server, is a combination of integrated software components and an allocation of computational resources, such as memory, a node, and processes on the node for executing the integrated software components, where the combination of the software and computational resources are dedicated to providing a particular type of function on behalf of clients of the server. A database server governs and facilitates access to a particular database, processing requests by clients to access the database.

A database comprises data and metadata that is stored on a persistent memory mechanism, such as a set of hard disks. Such data and metadata may be stored in a database logically, for example, according to relational and/or object-relational database constructs.

Users interact with a database server of a DBMS by submitting to the database server commands that cause the database server to perform operations on data stored in a database. A user may be one or more applications running on a client computer that interact with a database server. Multiple users may also be referred to herein collectively as a user.

A database command may be in the form of a database statement. For the database server to process the database statements, the database statements must conform to a database language supported by the database server. One non-limiting example of a database language that is supported by many database servers is SQL, including proprietary forms of SQL supported by such database servers as Oracle, (e.g. Oracle Database 11 g). SQL data definition language (“DDL”) instructions are issued to a database server to create or configure database objects, such as tables, views, or complex types. Data manipulation language (“DML”) instructions are issued to a DBMS to manage data stored within a database structure. For instance, SELECT, INSERT, UPDATE, and DELETE are common examples of DML instructions found in some SQL implementations. SQL/XML is a common extension of SQL used when manipulating XML data in an object-relational database.

Generally, data is stored in a database in one or more data containers, each container contains records, and the data within each record is organized into one or more fields. In relational database systems, the data containers are typically referred to as tables, the records are referred to as rows, and the fields are referred to as columns. In object-oriented databases, the data containers are typically referred to as object classes, the records are referred to as objects, and the fields are referred to as attributes. Other database architectures may use other terminology. Systems that implement the present invention are not limited to any particular type of data container or database architecture. However, for the purpose of explanation, the examples and the terminology used herein shall be that typically associated with relational or object-relational databases. Thus, the terms “table”, “row” and “column” shall be used herein to refer respectively to the data container, record, and field.

Query Optimization and Execution Plans

Query optimization generates one or more different candidate execution plans for a query, which are evaluated by the query optimizer to determine which execution plan should be used to compute the query.

Execution plans may be represented by a graph of interlinked nodes, each representing an plan operator or row sources. The hierarchy of the graphs (i.e., directed tree) represents the order in which the execution plan operators are performed and how data flows between each of the execution plan operators.

An operator, as the term is used herein, comprises one or more routines or functions that are configured for performing operations on input rows or tuples to generate an output set of rows or tuples. The operations may use interim data structures. Output set of rows or tuples may be used as input rows or tuples for a parent operator.

An operator may be executed by one or more computer processes or threads. Referring to an operator as performing an operation means that a process or thread executing functions or routines of an operator are performing the operation.

A row source performs operations on input rows and generates output rows, which may serve as input to another row source. The output rows may be new rows, and or a version of the input rows that have been transformed by the row source.

A match operator of a path pattern expression performs operations on a set of input matching vertices and generates a set of output matching vertices, which may serve as input to another match operator in the path pattern expression. The match operator performs logic over multiple vertex/edges to generate the set of output matching vertices for a specific hop of a target pattern corresponding to the path pattern expression.

An execution plan operator generates a set of rows (which may be referred to as a table) as output and execution plan operations include, for example, a table scan, an index scan, sort-merge join, nested-loop join, filter, and importantly, a full outer join.

A query optimizer may optimize a query by transforming the query. In general, transforming a query involves rewriting a query into another semantically equivalent query that should produce the same result and that can potentially be executed more efficiently, i.e. one for which a potentially more efficient and less costly execution plan can be generated. Examples of query transformation include view merging, subquery unnesting, predicate move-around and pushdown, common subexpression elimination, outer-to-inner join conversion, materialized view rewrite, and star transformation.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

For example, FIG. 10 is a block diagram that illustrates a computer system 1000 upon which an embodiment of the invention may be implemented. Computer system 1000 includes a bus 1002 or other communication mechanism for communicating information, and a hardware processor 1004 coupled with bus 1002 for processing information. Hardware processor 1004 may be, for example, a general purpose microprocessor.

Computer system 1000 also includes a main memory 1006, such as a random access memory (RAM) or other dynamic storage device, coupled to bus 1002 for storing information and instructions to be executed by processor 1004. Main memory 1006 also may be used for storing temporary variables or other intermediate information during execution of instructions to be executed by processor 1004. Such instructions, when stored in non-transitory storage media accessible to processor 1004, render computer system 1000 into a special-purpose machine that is customized to perform the operations specified in the instructions.

Computer system 1000 further includes a read only memory (ROM) 1008 or other static storage device coupled to bus 1002 for storing static information and instructions for processor 1004. A storage device 1010, such as a magnetic disk, optical disk, or solid-state drive is provided and coupled to bus 1002 for storing information and instructions.

Computer system 1000 may be coupled via bus 1002 to a display 1012, such as a cathode ray tube (CRT), for displaying information to a computer user. An input device 1014, including alphanumeric and other keys, is coupled to bus 1002 for communicating information and command selections to processor 1004. Another type of user input device is cursor control 1016, such as a mouse, a trackball, or cursor direction keys for communicating direction information and command selections to processor 1004 and for controlling cursor movement on display 1012. This input device typically has two degrees of freedom in two axes, a first axis (e.g., x) and a second axis (e.g., y), that allows the device to specify positions in a plane.

Computer system 1000 may implement the techniques described herein using customized hard-wired logic, one or more ASICs or FPGAs, firmware and/or program logic which in combination with the computer system causes or programs computer system 1000 to be a special-purpose machine. According to one embodiment, the techniques herein are performed by computer system 1000 in response to processor 1004 executing one or more sequences of one or more instructions contained in main memory 1006. Such instructions may be read into main memory 1006 from another storage medium, such as storage device 1010. Execution of the sequences of instructions contained in main memory 1006 causes processor 1004 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 1010. Volatile media includes dynamic memory, such as main memory 1006. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 1002. Transmission media can also take the form of acoustic or light waves, such as those generated during radio-wave and infra-red data communications.

Various forms of media may be involved in carrying one or more sequences of one or more instructions to processor 1004 for execution. For example, the instructions may initially be carried on a magnetic disk or solid-state drive of a remote computer. The remote computer can load the instructions into its dynamic memory and send the instructions over a telephone line using a modem. A modem local to computer system 1000 can receive the data on the telephone line and use an infra-red transmitter to convert the data to an infra-red signal. An infra-red detector can receive the data carried in the infra-red signal and appropriate circuitry can place the data on bus 1002. Bus 1002 carries the data to main memory 1006, from which processor 1004 retrieves and executes the instructions. The instructions received by main memory 1006 may optionally be stored on storage device 1010 either before or after execution by processor 1004.

Computer system 1000 also includes a communication interface 1018 coupled to bus 1002. Communication interface 1018 provides a two-way data communication coupling to a network link 1020 that is connected to a local network 1022. For example, communication interface 1018 may be an integrated services digital network (ISDN) card, cable modem, satellite modem, or a modem to provide a data communication connection to a corresponding type of telephone line. As another example, communication interface 1018 may be a local area network (LAN) card to provide a data communication connection to a compatible LAN. Wireless links may also be implemented. In any such implementation, communication interface 1018 sends and receives electrical, electromagnetic, or optical signals that carry digital data streams representing various types of information.

Network link 1020 typically provides data communication through one or more networks to other data devices. For example, network link 1020 may provide a connection through local network 1022 to a host computer 1024 or to data equipment operated by an Internet Service Provider (ISP) 1026. ISP 1026 in turn provides data communication services through the worldwide packet data communication network now commonly referred to as the “Internet” 1028. Local network 1022 and Internet 1028 both use electrical, electromagnetic, or optical signals that carry digital data streams. The signals through the various networks and the signals on network link 1020 and through communication interface 1018, which carry the digital data to and from computer system 1000, are example forms of transmission media.

Computer system 1000 can send messages and receive data, including program code, through the network(s), network link 1020 and communication interface 1018. In the Internet example, a server 1030 might transmit a requested code for an application program through Internet 1028, ISP 1026, local network 1022 and communication interface 1018.

The received code may be executed by processor 1004 as it is received, and/or stored in storage device 1010, or other non-volatile storage for later execution.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g. content of registers) between allotments of the hardware processor time when the computer system process is not running. Computer system processes run under the control of an operating system, and may run under the control of other programs being executed on the computer system.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

### Software Overview

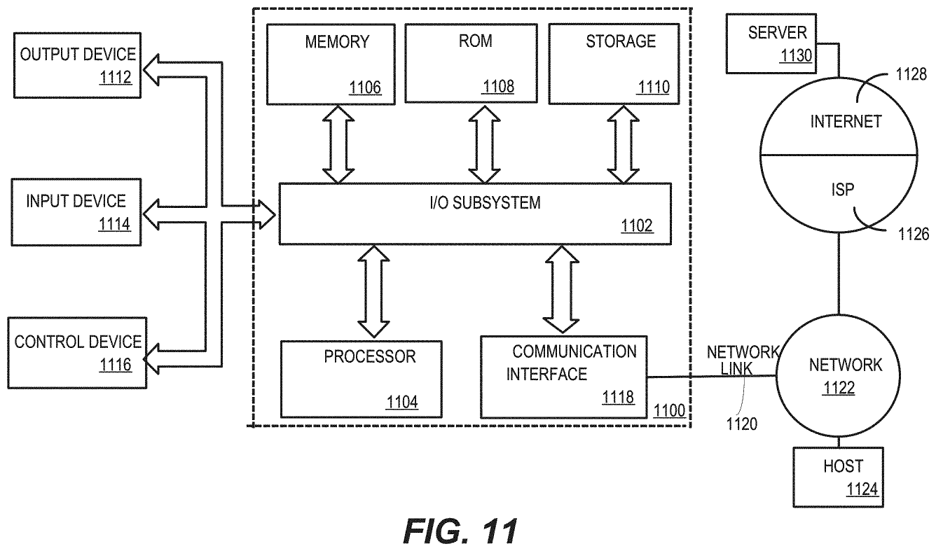

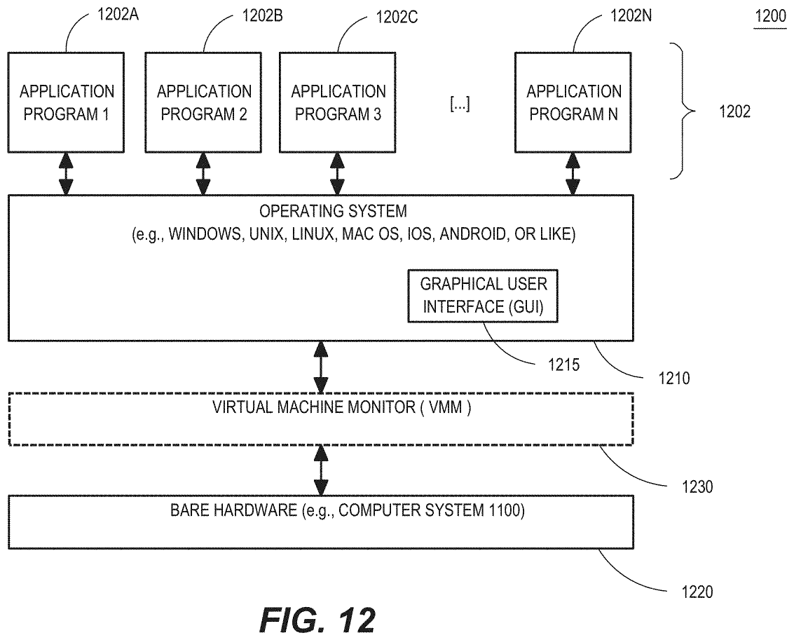

FIG. 11 is a block diagram of a basic software system 1100 that may be employed for controlling the operation of computing device 1000. Software system 1100 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 1100 is provided for directing the operation of computing device 1000. Software system 1100, which may be stored in system memory (RAM) 1006 and on fixed storage (e.g., hard disk or flash memory) 1010, includes a kernel or operating system (OS) 1110.

The OS 1110 manages low-level aspects of computer operation, including managing execution of processes, memory allocation, file input and output (I/O), and device I/O. One or more application programs, represented as 1102A, 1102B, 1102C . . . 1102N, may be “loaded” (e.g., transferred from fixed storage 1010 into memory 1006) for execution by the system 1100. The applications or other software intended for use on device 1100 may also be stored as a set of downloadable computer-executable instructions, for example, for downloading and installation from an Internet location (e.g., a Web server, an app store, or other online service).

Software system 1100 includes a graphical user interface (GUI) 1115, for receiving user commands and data in a graphical (e.g., “point-and-click” or “touch gesture”) fashion. These inputs, in turn, may be acted upon by the system 1100 in accordance with instructions from operating system 1110 and/or application(s) 1102. The GUI 1115 also serves to display the results of operation from the OS 1110 and application(s) 1102, whereupon the user may supply additional inputs or terminate the session (e.g., log off).

OS 1110 can execute directly on the bare hardware 1120 (e.g., processor(s) 1004) of device 1000. Alternatively, a hypervisor or virtual machine monitor (VMM) 1130 may be interposed between the bare hardware 1120 and the OS 1110. In this configuration, VMM 1130 acts as a software “cushion” or virtualization layer between the OS 1110 and the bare hardware 1120 of the device 1000.

VMM 1130 instantiates and runs one or more virtual machine instances (“guest machines”). Each guest machine comprises a “guest” operating system, such as OS 1110, and one or more applications, such as application(s) 1102, designed to execute on the guest operating system. The VMM 1130 presents the guest operating systems with a virtual operating platform and manages the execution of the guest operating systems.

In some instances, the VMM 1130 may allow a guest operating system to run as if it is running on the bare hardware 1120 of device 1000 directly. In these instances, the same version of the guest operating system configured to execute on the bare hardware 1120 directly may also execute on VMM 1130 without modification or reconfiguration. In other words, VMM 1130 may provide full hardware and CPU virtualization to a guest operating system in some instances.

In other instances, a guest operating system may be specially designed or configured to execute on VMM 1130 for efficiency. In these instances, the guest operating system is “aware” that it executes on a virtual machine monitor. In other words, VMM 1130 may provide para-virtualization to a guest operating system in some instances.

The above-described basic computer hardware and software is presented for purpose of illustrating the basic underlying computer components that may be employed for implementing the example embodiment(s). The example embodiment(s), however, are not necessarily limited to any particular computing environment or computing device configuration. Instead, the example embodiment(s) may be implemented in any type of system architecture or processing environment that one skilled in the art, in light of this disclosure, would understand as capable of supporting the features and functions of the example embodiment(s) presented herein.

### Extensions and Alternatives

Although some of the figures described in the foregoing specification include flow diagrams with steps that are shown in an order, the steps may be performed in any order, and are not limited to the order shown in those flowcharts. Additionally, some steps may be optional, may be performed multiple times, and/or may be performed by different components. All steps, operations and functions of a flow diagram that are described herein are intended to indicate operations that are performed using programming in a special-purpose computer or general-purpose computer, in various embodiments. In other words, each flow diagram in this disclosure, in combination with the related text herein, is a guide, plan or specification of all or part of an algorithm for programming a computer to execute the functions that are described. The level of skill in the field associated with this disclosure is known to be high, and therefore the flow diagrams and related text in this disclosure have been prepared to convey information at a level of sufficiency and detail that is normally expected in the field when skilled persons communicate among themselves with respect to programs, algorithms and their implementation.

In the foregoing specification, the example embodiment(s) of the present invention have been described with reference to numerous specific details. However, the details may vary from implementation to implementation according to the requirements of the particular implement at hand. The example embodiment(s) are, accordingly, to be regarded in an illustrative rather than a restrictive sense.

What is claimed is:

1. A method comprising:
generating, on a local node, an in-memory representation for a graph distributed on a plurality of nodes including the local node and remote nodes, the graph comprising a plurality of vertices connected by a plurality of edges, wherein each of the plurality of edges is directed from a respective source vertex to a respective destination vertex;
wherein generating the in-memory representation for the graph includes generating at least one graph array, each comprising:
a shared array accessible by the remote nodes; and
one or more delta logs comprising at least one of:
an update map comprising updates to the shared array by the local node; and
an appended array comprising new entries to the shared array by the local node.

2. The method of claim 1, wherein generating the in-memory representation for the graph includes generating a dictionary comprising:
a shared map for mapping vertex keys to a tuple, wherein the shared map is duplicated on the remote nodes, and wherein the tuple comprises:
a node identifier of the plurality of nodes;
a vertex table identifier of the at least one graph array; and
a vertex index of the vertex table identifier; and
a local map for updates to the shared map by the local node.

3. The method of claim 2, further comprising:
receiving a request to generate a new snapshot of the graph;
accessing the dictionary to identify a plurality of vertex and edge tables on the plurality of nodes;
accessing, by reference, shared arrays of the plurality of vertex and edge tables from the remote nodes;
replicating delta logs of the plurality of vertex and edge tables from the remote nodes;
propagating vertex and edge deletions from the replicated delta logs to the remote nodes; and
applying the replicated delta logs and the one or more delta logs of the at least one graph array to generate the new snapshot of the graph at the local node.

4. The method of claim 1, wherein generating the at least one graph array includes: generating at least one property array to be associated with the plurality of vertices in the in-memory representation for the graph.

5. The method of claim 1, wherein generating the at least one graph array includes: generating at least one property array to be associated with the plurality of edges in the in-memory representation for the graph.

6. The method of claim 1, wherein generating the at least one graph array includes: generating at least one key array to be associated with the plurality of vertices.

7. The method of claim 1, wherein generating the at least one graph array includes: generating a vertex array and an edge array in compressed sparse row (CSR) format.

8. The method of claim 7, wherein one of the one or more delta logs references an existing vertex in the shared array of the vertex array while referencing the appended array of the edge array.

9. The method of claim 1, wherein the plurality of vertices is distributed using a hash function that provides randomness that approximately uniformly distributes the plurality of vertices across the plurality of nodes according to vertex degree.

10. The method of claim 1, wherein the at least one graph array includes a vertex array that includes a reserved portion for storing at least one ghost vertex, wherein the at least one ghost vertex exceeds a degree threshold and is duplicated on each of the remote nodes.

11. The method of claim 1, wherein the one or more delta logs comprise a deleted bitset array to indicate whether an element is deleted in the shared array or in the appended array.

12. The method of claim 1, further comprising:
receiving a request to access the at least one graph array via an iterator; and
in response to the request, providing logical access to the at least one graph array by returning a reconstruction of applying the delta logs on the shared array.

13. The method of claim 1, further comprising:
determining that the one or more delta logs of the at least one graph array exceeds a threshold size;
applying the update map and the appended array to the shared array of the at least one graph array; and
emptying the one or more delta logs of the at least one graph array.

14. The method of claim 1, further comprising:
determining that delta logs of a vertex and edge table of the at least one graph array exceeds a threshold size, wherein the vertex and edge table use a CSR format;
applying the update map and the appended array to the shared array of the vertex and edge table; and
emptying the delta logs of the vertex and edge table.

15. The method of claim 1, further comprising:
determining that delta logs of the graph exceed a threshold size; and
causing the in-memory representation for the graph at each of the plurality of nodes to be updated such that the delta logs of the graph are applied and emptied.

16. The method of claim 15, further comprising:
determining updated vertex degrees of the plurality of vertices; and
redistributing the plurality of vertices across the plurality of nodes according to a hash function that provides randomness that approximates a uniform distribution of the updated vertex degrees.

17. The method of claim 1, further comprising:
organizing the at least one graph array into fixed size segments;
determining that delta logs of a first segment of the fixed size segments exceeds a threshold size;
applying the update maps and the appended arrays to the shared arrays of the first segment; and
emptying the delta logs of the first segment.

18. One or more non-transitory computer-readable media storing instructions that, when executed by one or more processors, cause:
generating, on a local node, an in-memory representation for a graph distributed on a plurality of nodes including the local node and remote nodes, the graph comprising a plurality of vertices connected by a plurality of edges, wherein each of the plurality of edges is directed from a respective source vertex to a respective destination vertex;
wherein generating the in-memory representation for the graph includes generating at least one graph array, each comprising:
a shared array accessible by the remote nodes; and
one or more delta logs comprising at least one of:
an update map comprising updates to the shared array by the local node; and
an appended array comprising new entries to the shared array by the local node.

19. The one or more non-transitory computer-readable media of claim 18, wherein the instructions cause generating the in-memory representation for the graph to include generating a dictionary comprising:
a shared map for mapping vertex keys to a tuple, wherein the shared map is duplicated on the remote nodes, and wherein the tuple comprises:
a node identifier of the plurality of nodes;
a vertex table identifier of the at least one graph array; and
a vertex index of the vertex table identifier; and
a local map for updates to the shared map by the local node.

20. The one or more non-transitory computer-readable media of claim 19, wherein the instructions further cause:
receiving a request to generate a new snapshot of the graph;
accessing the dictionary to identify a plurality of vertex and edge tables on the plurality of nodes;
accessing, by reference, shared arrays of the plurality of vertex and edge tables from the remote nodes;
replicating delta logs of the plurality of vertex and edge tables from the remote nodes;
propagating vertex and edge deletions from the replicated delta logs to the remote nodes; and
applying the replicated delta logs and the one or more delta logs of the at least one graph array to generate the new snapshot of the graph at the local node.
